(19) United States
(12) Patent Application Publication
(10) Pub. No.: US 2019/0354545 A1
(43) Pub. Date: Nov. 21, 2019

(54) SEARCH DEVICE, SEARCH METHOD AND SEARCH PROGRAM

(71) Applicant: FANUC CORPORATION, Minamitsuru-gun (JP)

(72) Inventor: Masao KAMIGUCHI, Yamanashi (JP)

(21) Appl. No.: 16/401,827

(22) Filed: May 2, 2019

(30) Foreign Application Priority Data
May 16, 2018 (JP) 2018-094550

(51) Int. Cl. G06F 16/33; G06F 17/22

(52) U.S. Cl. CPC G06F 16/3334; G06F 17/2276; G06F 16/3344

(57) ABSTRACT

A search device includes: a module feature amount calculation unit which extracts a keyword group from each of a plurality of modules obtained by dividing a document and which calculates data characterizing the keyword group as a feature amount for the module; a search feature amount calculation unit which receives a search request using a natural sentence so as to extract a keyword group from the natural sentence and which calculates data characterizing the keyword group as a feature amount for the search request; and a module selection unit which selects, based on the degrees of matching between the feature amounts for the individual modules and the feature amount for the search request, a module corresponding to the search request as the result of a search.

This application is based on and claims the benefit of priority from Japanese Patent Application No. 2018-94550, filed on 16 May 2018, the content of which is incorporated herein by reference.

### BACKGROUND OF THE INVENTION

### Field of the Invention

The present invention relates to a search device, a search method and a search program for documents.

### Related Art

Conventionally, when products such as an industrial machine and an electronic device are utilized, various types of documents such as an instruction manual and a maintenance manual are referenced as necessary by an operator, a manager and the like. In these types of documents, since the technical details thereof are related to a large number of portions such as a controller, software and machine parts, even when a table of contents or indexes are utilized, it is difficult to find the intended description. Hence, although documents are digitized and a full text search technology is developed, it is difficult to search results extracted by a keyword search for a description corresponding to the intention.

Patent document 1 proposes a technology in which an exclusive keyword for a keyword is utilized and in which thus the accuracy of a search is enhanced. Patent document 2 proposes a technology in which the range of a search is restricted by a table of contents and in which thus the accuracy of the search is enhanced. Patent document 3 proposes a technology in which the history of a keyword selection is displayed and in which thus the accuracy of a search is enhanced.
Patent Document 1: Japanese Unexamined Patent Application, Publication No. 2018-5637
Patent Document 2: Japanese Unexamined Patent Application, Publication No. H11-338605
Patent Document 3: Japanese Unexamined Patent Application, Publication No. H08-44755

### SUMMARY OF THE INVENTION

However, when a large number of portions are extracted by a keyword search from documents, since intended details are referenced, it takes time for a user himself or herself to make a selection.

An object of the present invention is to provide a search device, a search method and a search program which make a search using a natural sentence so as to be able to accurately extract an intended portion from documents.

(1) A search device (for example, a search device 1 which will be described later) according to the present invention includes: a module feature amount calculation unit (for example, a module feature amount calculation unit 12 which will be described later) which extracts a keyword group from each of a plurality of modules obtained by dividing a document and which calculates data characterizing the keyword group as a feature amount for the module; a search feature amount calculation unit (for example, a search feature amount calculation unit 13 which will be described later) which receives a search request using a natural sentence so as to extract a keyword group from the natural sentence and which calculates data characterizing the keyword group as a feature amount for the search request; and a module selection unit (for example, a module selection unit 14 which will be described later) which selects, based on the degrees of matching between the feature amounts for the individual modules and the feature amount for the search request, a module corresponding to the search request as the result of a search.

(2) In the search device described in (1), the search feature amount calculation unit may select the keyword group based on an appearance frequency.

(3) The search device described in (1) or (2) may include a module production unit (for example, a module production unit 11 which will be described later) which divides the document in units of headings so as to produce the modules.

(4) In the search device described in any one of (1) to (3), keywords extracted in the module feature amount calculation unit and the search feature amount calculation unit may be converted into general words with a predetermined conversion dictionary (for example, a conversion dictionary data 23 which will be described later).

(5) In the search device described in any one of (1) to (4), an extraction algorithm for the keywords in the module feature amount calculation unit and an extraction algorithm for the keywords in the search feature amount calculation unit may be common.

(6) The search device described in any one of (1) to (5) may include a database (for example, a content database 30 which will be described later) in which the modules and the feature amounts for the modules are associated with each other so as to be stored.

(7) In the search device described in (6), a plurality of the databases are provided for product makers or part makers respectively.

(8) In the search device described in (7), the search request may include a section for identifying the maker, and the module selection unit may select, from the database corresponding to the section, the module corresponding to the search request as the result of the search.

(9) In the search device described in any one of (6) to (8), a person who acquires a membership ID may be allowed to access the database.

(10) In the search device described in any one of (1) to (9), the document may be a manual of a product or a part.

(11) In a search method according to the present invention, a computer (for example, a search device 1 which will be described later) executes: a module feature amount calculation step of extracting a keyword group from each of a plurality of modules obtained by dividing a document and calculating data characterizing the keyword group as a feature amount for the module; a search feature amount calculation step of receiving a search request using a natural sentence so as to extract a keyword group from the natural sentence and calculating data characterizing the keyword group as a feature amount for the search request; and a module selection step of selecting, based on the degrees of matching between the feature amounts for the individual modules and the feature amount for the search request, a module corresponding to the search request as the result of a search.

(12) A search program according to the present invention makes a computer (for example, a search device 1 which will be described later) execute: a module feature amount calculation step of extracting a keyword group from each of a plurality of modules obtained by dividing a document and calculating data characterizing the keyword group as a feature amount for the module; a search feature amount calculation step of receiving a search request using a natural sentence so as to extract a keyword group from the natural sentence and calculating data characterizing the keyword group as a feature amount for the search request; and a module selection step of selecting, based on the degrees of matching between the feature amounts for the individual modules and the feature amount for the search request, a module corresponding to the search request as the result of a search.

According to the present invention, it is possible to make a search using a natural sentence so as to be able to accurately extract an intended portion from documents. Even when the Internet is used, a user can directly search contents, and thus safety is enhanced.

### BRIEF DESCRIPTION OF THE DRAWINGS

FIG. 1 is a block diagram showing the configuration of functions of a search device according to an embodiment;

FIG. 2 is a flowchart showing storage processing for document data which is a search target in the search method of the search device according to the present embodiment;

FIG. 3 is a flowchart showing processing for actually outputting the result of a search for a search request in the search method of the search device according to the present embodiment;

FIG. 4 is a diagram showing a first configuration example of a search system which includes the search devices according to the embodiment; and

FIG. 5 is a diagram showing a second configuration example of a search system which includes the search device according to the present embodiment.

### DETAILED DESCRIPTION OF THE INVENTION

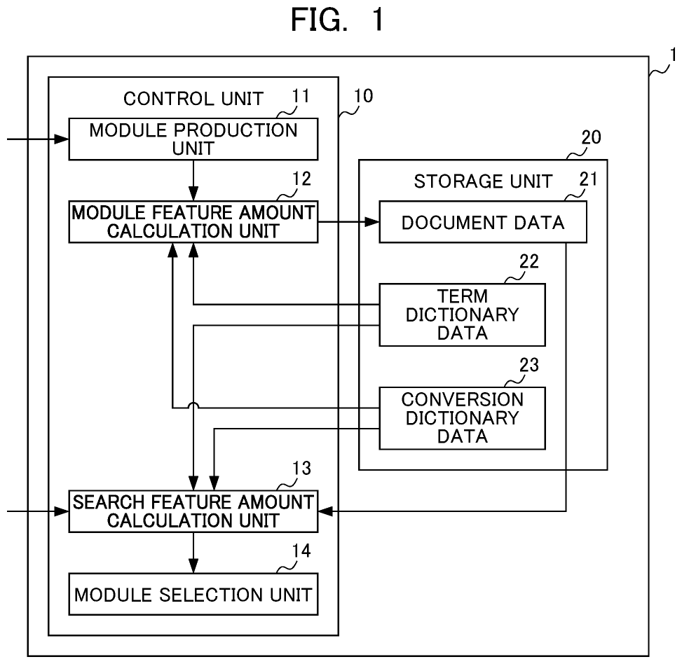

An example of the embodiment of the present invention will be described below. FIG. 1 is a block diagram showing the configuration of functions of a search device 1 according to the present embodiment. The search device 1 is an information processing device which includes a control unit 10 and a storage unit 20 and various types of interfaces for input/output, communication and the like. The search device 1 may be mounted as various electronic devices such as a server, a personal computer, a smartphone, a tablet terminal, a game machine, a navigation device and household electrical appliances.

The control unit 10 is a portion which controls the entire search device 1, and reads and executes various types of programs stored in the storage unit 20 as necessary so as to realize various types of functions in the present embodiment. The control unit 10 may be a CPU.

The storage unit 20 is a storage region of various types of programs, various types of data and the like for making a hardware group function as the search device 1, and may be a ROM, a RAM, a flash memory, a hard disk drive (HDD) or the like. Specifically, the storage unit 20 stores a search program for making the control unit 10 perform the individual functions of the present embodiment, document data 21 which is a search target, term dictionary data 22 for detecting keywords, conversion dictionary data 23 for unifying equivalent words and synonyms and the like. These types of data may be provided outside the search device 1 and may be read and written by communication with the search device 1.

The control unit 10 includes a module production unit 11, a module feature amount calculation unit 12, a search feature amount calculation unit 13 and a module selection unit 14, and uses these function units so as to output the result of a search of document data for an inquiry using a natural sentence.

The module production unit 11 divides a document serving as a search target in units of headings such as chapters or sections in a table of contents, produces a plurality of modules and stores them as the document data 21 in the storage unit 20.

The module feature amount calculation unit 12 extracts keywords defined in the term dictionary data 22 from the individual modules obtained by dividing the document. Then, the module feature amount calculation unit 12 uses the conversion dictionary data 23 so as to convert the extracted keywords into general words, and thereafter calculates data characterizing keyword groups as feature amounts for the individual modules.

The feature amount includes, for example, keywords themselves and information such as the ranks of frequencies of the individual keywords. In this way, frequency keywords are registered as the feature amount per module. Keywords whose appearance frequencies are less than a predetermined appearance frequency may be omitted from the feature amount.

The search feature amount calculation unit 13 receives a search request using a natural sentence so as to extract a keyword group from the natural sentence as with the module feature amount calculation unit 12. Then, the search feature amount calculation unit 13 uses the conversion dictionary data 23 so as to convert the extracted keywords into general words, and thereafter calculates data characterizing the keyword group as a feature amount for the search request.

The module selection unit 14 selects, based on the degrees of matching between the feature amounts for the individual modules and the feature amount for the search request, a module corresponding to the search request as the result of the search. In this way, for example, a module in which a keyword included in the natural sentence of the search request appears frequently is output as the result of the search.

An extraction algorithm for keywords in the module feature amount calculation unit 12 and an extraction algorithm for keywords in the search feature amount calculation unit 13 are common. In this way, the same keywords based on the term dictionary data 22 are extracted from both the modules and the search request, and thus the compatibility of the feature amounts which are matched is enhanced.

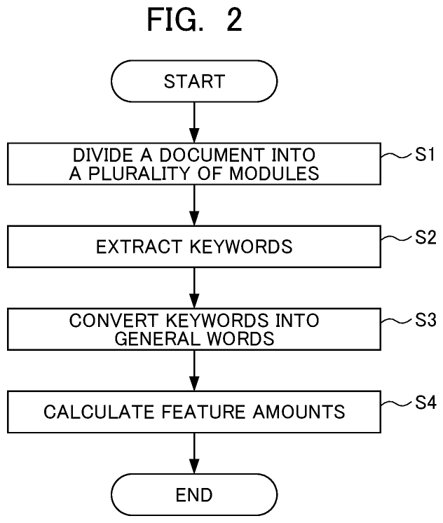

FIG. 2 is a flowchart showing storage processing for the document data 21 which is a search target in the search method of the search device 1 according to the present embodiment. In step S1, when the module production unit 11 receives an input of the document which is the search target, the module production unit 11 divides this document into a plurality of modules.

In step S2, the module feature amount calculation unit 12 extracts, from each of the modules, keywords included in the term dictionary data 22 together with frequency information.

In step S3, the module feature amount calculation unit 12 uses the conversion dictionary data 23 so as to convert the extracted keywords into general words.

In step S4, the module feature amount calculation unit 12 calculates, based on the appearance frequency of each of the keywords within the module, feature amounts for the individual modules which are expressed by the general word. The module feature amount calculation unit 12 individually associates the calculated feature amounts with the modules so as to store them in the storage unit 20 as the document data 21.

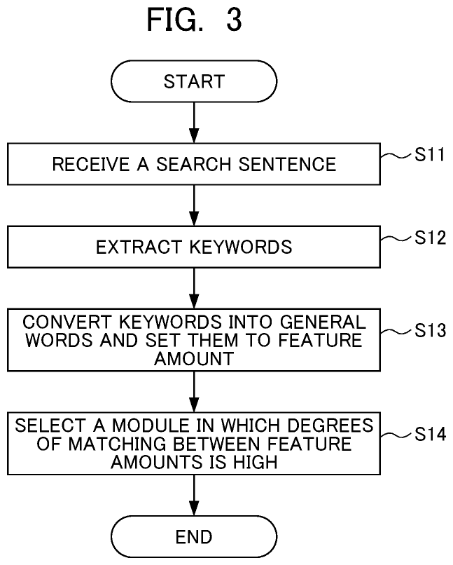

FIG. 3 is a flowchart showing processing for actually outputting the result of the search for the search request in the search method of the search device 1 according to the present embodiment. In step S11, the search feature amount calculation unit 13 receives a search sentence which is input as a natural sentence.

In step S12, the search feature amount calculation unit 13 extracts, from the received search sentence, keywords included in the term dictionary data 22.

In step S13, the search feature amount calculation unit 13 uses the conversion dictionary data 23 so as to convert the extracted keywords into general words, and sets them to the feature amount for the search sentence.

In step S14, the module selection unit 14 matches the feature amount for the search sentence with the feature amounts for the individual modules, selects a module in which the degrees of matching between the feature amounts is high and outputs it as the result of the search.

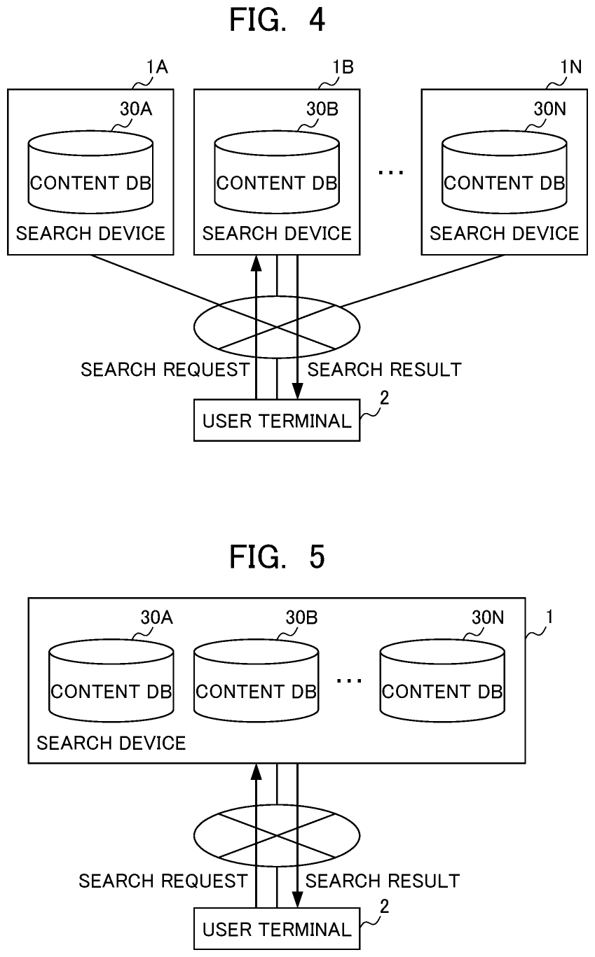

FIG. 4 is a diagram showing a first configuration example of a search system which includes the search devices 1 according to the present embodiment. In this example, a plurality of search devices 1A, 1B, . . . are provided for individual product and part makers such as a maker which manufactures machines, a controller maker, a tool maker, a measurement device maker, a part maker, a jig maker and a material maker.

The individual search devices 1 manage, as the document data 21 of search targets, manuals formed of various types of information such as an operation method, a maintenance method, a machining method, alarm information, an inspection method, tool information and material information for products such as a machine and a control system, and store them in content databases (DB) 30A, 30B, . . . .

A user terminal 2 selectively accesses, through a network, the search device 1 (for example, the search device 1B) of a maker specified by a user so as to transmit the search request. The search device 1 which receives the search request selects a module matching with the search request from manuals managed by the maker itself so as to transmit it back to the user terminal 2 as the result of the search. The search device 1 of each maker confirms authentication information such as the ID of the user so as to be able to allow access to the database and the search function, and can provide the ID to the user with the manual search set to a membership service.

FIG. 5 is a diagram showing a second configuration example of a search system which includes the search device 1 according to the present embodiment. In this example, the single search device 1 manages a plurality of contents DB 30A, 30B, . . . for the individual makers.

A user terminal 2 accesses the search device 1 through a network so as to transmit a search request. Here, the user terminal 2 may transmit a search request which includes a section for identifying a maker. The search device 1 selects, from a plurality of contents DB 30 managed by itself or a content DB 30 corresponding to the specified section, a module matching with the search request so as to transmit it back to the user terminal 2 as the result of the search. The search device 1 confirms authentication information such as the ID of the user for each of the makers or common authentication information for a plurality of makers so as to be able to allow access to the database and the search function corresponding thereto, and can provide the ID for each of the makers or the common ID to the user with the manual search set to a membership service.

In the first and second configuration examples described above, the user accesses the search device 1 through the network so as to search the documents. Preferably, in order to prevent the leakage of the documents and the search sentence to a third party, for example, a membership service is adopted as the service provided by the search device 1, and addresses and authentication information such as passwords are disclosed for only membership members. Communication data between the search device 1 and the user terminal 2 is encrypted, and thus safety is enhanced.

In the present embodiment, the search device 1 extracts, for each of modules obtained by dividing the document, keywords, and registers them as feature amounts. Then, when the search device 1 receives a search request, the search device 1 also extracts keywords from a search sentence and sets them to a feature amount. The search device 1 selects, based on the degrees of matching between the feature amounts for the individual modules and the feature amount for the search sentence, a module corresponding to the search request as the result of the search, and thus the search device 1 can extract part of the document matching with the search request in units of modules. Hence, the search device 1 makes a search using a natural sentence so as to be able to accurately extract an intended portion from the document

Even when the Internet is used, a general purpose search engine does not need to be used, and thus the user can directly search the contents, with the result that safety against the leakage of information to a third party is enhanced. Furthermore, the contents do not need to be described with a general purpose Web language, and thus expert knowledge does not need in order to produce and update manuals serving as contents, with the result that a workload is reduced.

Since the search device 1 selects a keyword group based on the appearance frequency of each of the keywords, the feature of the module is defined by important keywords, and thus it is possible to accurately extract a module matching with the intention of a search.

Since the search device 1 divides the document which is a search target in units of headings so as to produce modules, the search device 1 easily divides the single document in terms of meaning so as to be able to efficiently output only a necessary portion as the result of the search.

Since the search device 1 converts the extracted keywords into the general words and then defines the feature amounts, fluctuations in terms between the document and the search sentence are prevented, and thus it is possible to accurately extract the intended module.

When the search device 1 calculates the feature amounts for the modules and the feature amount for the search sentence, the common extraction algorithm for keywords are used, and thus the accuracy of matching between the search sentence and the modules is enhanced, with the result that it is possible to efficiently extract the intended module.

The search device 1 includes the database in which the modules of the document and the feature amounts are associated with each other, and thus the search device 1 itself can easily realize a document search.

The search device 1 manages a plurality of databases for respective makers, and thus a wide range of documents can be searched and the management of documents can be performed efficiently. Here, the search device 1 can restrict the range of the search by receiving, as the search request, the section for identifying the maker, and thus the search processing can be performed efficiently.

The search device 1 allows only a user who acquires a membership ID to access the databases prepared for the respective makers, and thus the disclosure of the documents to a third party is restricted, with the result that safety against the leakage of information can be enhanced.

The search device 1 manages, as the documents which are a search target, manuals on an industrial machine and accompanying products or parts so as to be able to efficiently provide a portion, that is, a module desired by the user from a very large number of manuals.

Although the embodiment of the present invention is described above, the present invention is not limited to the embodiment described above. The effects described in the present embodiment are simply a list of the most preferred effects produced from the present invention, and the effects of the present invention are not limited to those described in the present embodiment.

The search method of the search device 1 is realized by software. When the search method is realized by software, the programs of the software are installed in a computer (search device 1). These programs may be distributed to users by being recorded in removable media or may be distributed to users by being downloaded into computers of the users through networks.

### EXPLANATION OF REFERENCE NUMERALS

1 search device
10 control unit
11 module production unit
12 module feature amount calculation unit
13 search feature amount calculation unit
14 module selection unit
20 storage unit
21 document data
22 term dictionary data
23 conversion dictionary data

What is claimed is:

1. A search device comprising:
a module feature amount calculation unit which extracts a keyword group from each of a plurality of modules obtained by dividing a document and which calculates data characterizing the keyword group as a feature amount for the module;
a search feature amount calculation unit which receives a search request using a natural sentence so as to extract a keyword group from the natural sentence and which calculates data characterizing the keyword group as a feature amount for the search request; and
a module selection unit which selects, based on degrees of matching between the feature amounts for the individual modules and the feature amount for the search request, a module corresponding to the search request as a result of a search.

2. The search device according to claim 1, wherein
the search feature amount calculation unit selects the keyword group based on an appearance frequency.

3. The search device according to claim 1, comprising:
a module production unit which divides the document in units of headings so as to produce the modules.

4. The search device according to claim 1, wherein
keywords extracted in the module feature amount calculation unit and the search feature amount calculation unit are converted into general words with a predetermined conversion dictionary.

5. The search device according to claim 1, wherein
an extraction algorithm for the keywords in the module feature amount calculation unit and an extraction algorithm for the keywords in the search feature amount calculation unit are common.

6. The search device according to claim 1, comprising
a database in which the modules and the feature amounts for the modules are associated with each other so as to be stored.

7. The search device according to claim 6, wherein
a plurality of the databases are provided for product makers or part makers respectively.

8. The search device according to claim 7, wherein
the search request includes a section for identifying the maker, and
the module selection unit selects, from the database corresponding to the section, the module corresponding to the search request as the result of the search.

9. The search device according to claim 6, wherein
a person who acquires a membership ID is allowed to access the database.

10. The search device according to claim 1, wherein
the document is a manual of a product or a part.

11. A search method in which a computer executes:
a module feature amount calculation step of extracting a keyword group from each of a plurality of modules obtained by dividing a document and calculating data characterizing the keyword group as a feature amount for the module;
a search feature amount calculation step of receiving a search request using a natural sentence so as to extract a keyword group from the natural sentence and calculating data characterizing the keyword group as a feature amount for the search request; and
a module selection step of selecting, based on degrees of matching between the feature amounts for the individual modules and the feature amount for the search request, a module corresponding to the search request as a result of a search.

12. A non-transitory computer readable medium which records a search program that makes a computer execute:
a module feature amount calculation step of extracting a keyword group from each of a plurality of modules obtained by dividing a document and calculating data characterizing the keyword group as a feature amount for the module;
a search feature amount calculation step of receiving a search request using a natural sentence so as to extract a keyword group from the natural sentence and calculating data characterizing the keyword group as a feature amount for the search request; and
a module selection step of selecting, based on degrees of matching between the feature amounts for the individual modules and the feature amount for the search request, a module corresponding to the search request as a result of a search.
